(19) United States
(12) Patent Application Publication
(10) Pub. No.: US 2011/0073677 A1
(43) Pub. Date: Mar. 31, 2011

(54) SPRAYER SYSTEM

(76) Inventors: Klaus Karl Hahn, Braselton, GA (US); Michael R. Gardner, Anderson, SC (US); Charles Keith Long, Seneca, SC (US)

(21) Appl. No.: 12/959,855

(22) Filed: Dec. 3, 2010

Related U.S. Application Data
(63) Continuation of application No. 12/012,645, filed on Feb. 5, 2008.
(60) Provisional application No. 60/900,153, filed on Feb. 7, 2007.

(51) Int. Cl. B05B 7/02; B05B 15/00

(52) U.S. Cl. 239/311; 239/127

(57) ABSTRACT

A fluid sprayer includes a housing, a motor positioned within the housing, a pump operably coupled to the motor to draw fluid from a fluid source and pressurize the fluid, and a blower positioned within the housing and operable to discharge an airflow into the pressurized fluid discharged by the pump.

### CROSS-REFERENCE TO RELATED APPLICATIONS

This application is a continuation of co-pending U.S. patent application Ser. No. 12/012,645 filed on Feb. 5, 2008, which claims priority to U.S. Provisional Patent Application No. 60/900,153 filed on Feb. 7, 2007, the entire contents of all of which are incorporated herein by reference.

### BACKGROUND OF THE INVENTION

The present application relates to sprayer systems, and, in particular, to sprayer systems for applying a fluid.

Sprayers such as paint guns are used to apply a fluid such as paint to a surface such as a wall, furniture of the exterior of a building. In general, there are two types of sprayers, airless piston pump spray guns and sprayers that incorporate HVLP (high-volume, low-pressure) technology.

Airless piston pump spray guns utilize a piston pump system that is used to create a vacuum to draw paint from a paint container (i.e. cup, bucket or direct from 5 gallon pail) and to push paint through a paint nozzle. The paint is often pressurized in the range of 1800-2600 pounds per square inch. Under such high pressure, the paint often will disperse, or splatter, causing the paint to disperse in an uncontrolled fashion such that a large amount of paint must be applied to adequately paint a surface. This is known as an overspray effect. Moreover, splatter may cause unwanted paint to get on surfaces or objects other than the surface to be painted. Furthermore, a relatively high amount of noise may be generated by the operation of the piston pump. Finally, such systems require that high-viscosity paint, such as latex, be diluted prior to use, again wasting materials.

HVLP technology involves using a turbine to create a venturi effect in order to draw paint through a tube to be dispersed. However, if the paint is too thick, the pressure generated by the turbine may be insufficient to draw the paint through the tube so that the paint will fail to pass through the sprayer's nozzle. Thus, as with the airless piston pump spray guns, the paint must be diluted prior to use.

### SUMMARY OF THE INVENTION

The present invention provides, in one aspect, a fluid sprayer including a housing, a motor positioned within the housing, a pump operably coupled to the motor to draw fluid from a fluid source and pressurize the fluid, and a blower positioned within the housing and operable to discharge an airflow into the pressurized fluid discharged by the pump.

Other features and aspects of the invention will become apparent by consideration of the following detailed description and accompanying drawings.

### BRIEF DESCRIPTION OF THE DRAWINGS

FIG. 1 is a view of an embodiment of a sprayer system according to the present invention.

FIG. 2 is a view of the sprayer system of FIG. 1 that includes a bypass valve.

FIG. 3 is view of the sprayer system of FIG. 2 that shows the bypass valve in a bypass mode.

FIG. 4 is view of the sprayer system of FIG. 2 that shows the bypass valve in a partial bypass mode.

FIG. 5 is an alternate embodiment of a sprayer system.

FIG. 6 is an alternate embodiment of a sprayer system with an implement.

FIG. 7 shows the sprayer system of FIG. 5 with a receptacle holding a container of fluid.

FIG. 8 is a flow diagram of a base station and spray mechanism.

FIG. 9 is the flow diagram of FIG. 7 that additionally includes a bypass valve.

FIG. 10 is the flow diagram of FIG. 8 that additionally includes a quick-connect valve.

FIG. 11 shows various implements for use with the sprayer system.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

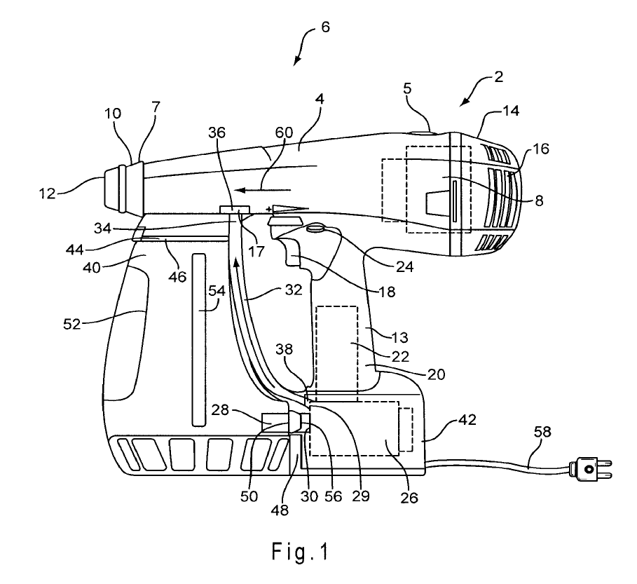

Referring to FIG. 1, a novel sprayer system 2 is shown and described herein for the dispensing of a fluid such as paint, stain, or pesticides. The sprayer system 2 includes a spray mechanism 6, such as a spray gun, and a receptacle 40. The spray mechanism 6 includes a housing 4, a handle 20 and a base 42. The housing includes a blower motor 8. As described further below, the blower motor 8 provides a high-volume, low-pressure stream of air. Although the blower motors of different ratings can be used, generally sprayer systems will have an air capacity of 30-100 cubic feet per minute (cfm) and provide an air stream pressure of 1 through 3 pounds per square inch (psi). For non-professional use, i.e., consumer use, blower motors will have an air capacity of about 50 through 60 cfm. For professional, or contactor usage, the blower motor will have an air capacity of 80 through 100 cfm.

The housing also includes an outlet end 7, which includes a detachable nozzle 10. The nozzle 10 creates a spray of fluid as the fluid exits the outlet end. Preferably, the nozzle is a multi-setting type of nozzle that includes an adjustment dial 12 to allow the fluid to be sprayed on a surface in a variety of patterns, including, but not limited to, vertical, horizontal, oval, and circular patterns. In a preferred embodiment, the blower motor will be located at an end 14 of the housing 4 opposite the outlet end 7.

The housing also includes an air intake 16 for the entry of ambient air. While the intake can be located anywhere on the housing, depending on the shape of the housing, it is generally desirable to have the air intake located at the end 14 of the housing having the blower motor 8. A hose opening 17 is for the fluid attachment of a first end 34 of a fluid feeder line 32. As with the air intake 16, the hose opening 17 may be located any where about the housing 4, depending on the design of the housing, but should be located, with respect to FIG. 1, so that is forward of the blower motor 8. The hose opening and first end 34 of the fluid feeder line 32 together form a fluid injection point 36.

A handle 13 is attached to a lower surface of the housing. Although the handle can have a variety of shaped, preferably the handle has a grip-style shape and is overmolded with rubber to be ergonomically advantageous for a user. The handle 13 includes a trigger 18 that actuates the blower motor 8 and a pump motor 22 located in a cavity 20 within the handle 12. Preferably, the handle 13 includes a lock-on member 24 that engages the trigger 18 so that the trigger 18 remains in an actuated position without requiring the user to “hold” the trigger 18. Conversely, in alternate embodiments the lock-on member 24 may act as a lock-out in order to prevent the trigger 18 from actuating.

The pump motor 22 drives a pump 26 located in the base 42. The pump includes a pump outlet 38 that is attached to a second end 38 of the fluid feeder line 32. The pump 26 pressurizes fluid so that it exits the pump outlet 38 and is transported through the fluid feeder line 32 and to the fluid injection point 36. The pump 26 can be one of several types, including a peristaltic, impeller, or piston-type of pump. Preferably, the pump 26 will have a pressure rating of 5 through 10 psi.

The pump also includes a pump inlet tube 28 that provides for the delivery of fluid from the receptacle 40 to the pump 26. The receptacle 40 is removably connected with the spray mechanism 6. Preferably, a top edge 44 of the receptacle attaching to a lower edge 46 of the housing 4. The top edge 44 of the receptacle and the lower edge 46 of the housing 4 are slidably connected, but may also be attached through other connections, such as a snap-on connection or a clip-on connection. In alternate embodiments, the receptacle may also be attached to the spray mechanism 3 at a second location. For example, a side edge 48 of the receptacle 40 may be attached to the base 42. The receptacle also includes an opening 50 for receiving the pump inlet tube 28 to provide for the delivery of fluid from the receptacle into the pump. Preferably, the opening 50 includes a seal to reduce the leakage of fluid. A release 56 is provided that disconnects the receptacle from the spray mechanism 3. Alternatively and as further described below, the spray mechanism 6 need not be used in conjunction with the receptacle 40. Rather, the pump inlet tube may be extended and placed in a detached container.

Optionally, the receptacle includes a handle 52 that provides a secondary grip for a user of the sprayer system 2. Preferably the handle 52 is a recessed grip area, although other types of handles may be used. The receptacle 40 also may include a fill level indicator 54, which provides a visual indication of the amount of fluid inside the receptacle 40.

As shown in FIG. 1, the spray mechanism uses a cord 58 that is plugged into an AC power source. In alternate embodiments, the spray mechanism can utilize a cord that can be plugged into other sources, such as a car lighter. Alternatively, the spray mechanism can be powered for a DC source such as batteries, including rechargeable battery packs.

Operation of the sprayer system described thus far is as follows: a receptacle 52 containing a fluid, such as paint, is attached to the spray mechanism, with the pump inlet 28 being inserted into the opening 50. Upon actuation of the trigger 18, the blower motor 8 and the pump motor 22 are energized. The blower motor blows air entering the air intake 16 through the housing, creating an air stream indicated by arrow 60. Alternatively, the blower motor may be actuated by a separate switch so that it is constantly “on” (until the switch is depressed to deactuate the blower motor), while the pump motor is intermittently activated by engaging the trigger.

At the same time the air stream is being created, fluid is drawn into the pump and pressurized so that it flows through the fluid feeder line and to the fluid injection point. Upon reaching the fluid injection point 36, the fluid is injected into the air stream in the housing. The pressurized fluid combines with the air stream and exits the nozzle as high-volume, low-pressure spray. As described above, the adjustment dial 12 may be used to select a desired pattern.

Optionally, the spray mechanism may include a level indicator 5. If a user desires to “tilt” or “rotate” the spray mechanism in order to dispense fluid at an angle, the level indicator provides a visual indication of the degree rotation.

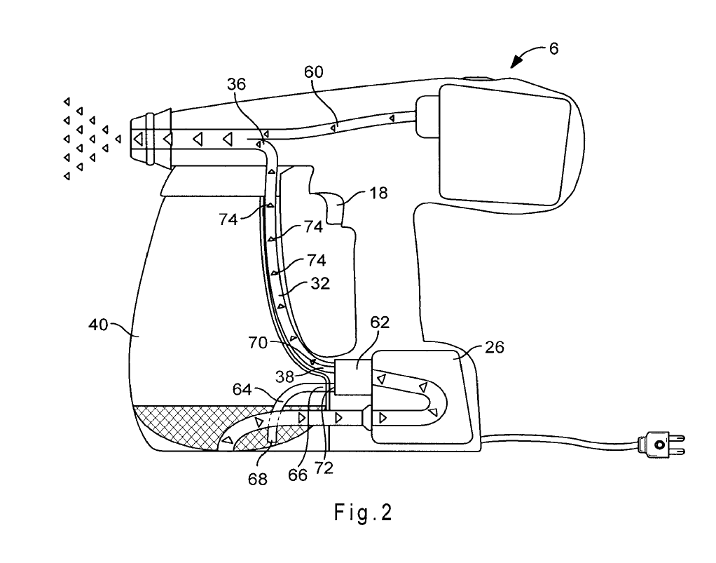

Referring now to FIG. 2, an alternate embodiment of the spray mechanism 6 is shown, with like components having like reference numerals. The spray mechanism includes a bypass valve 62 that is fluidly connected with the pump 26. The bypass valve 62, which preferably is a spring-loaded valve, controls the amount of fluid delivered to the fluid injection point 36 by providing a feed back loop, or hose, 64 to the fluid receptacle 40. In embodiments that include the bypass valve 62, the first end 34 of the fluid feeder line 32 is fluidly connected to a first valve opening 70 of the bypass valve 62. The feedback hose 64 is fluidly connected with a second valve opening 72 of the bypass valve at a first end 66. A second end 68 of the feedback hose 64 is in fluid communication with the receptacle 40.

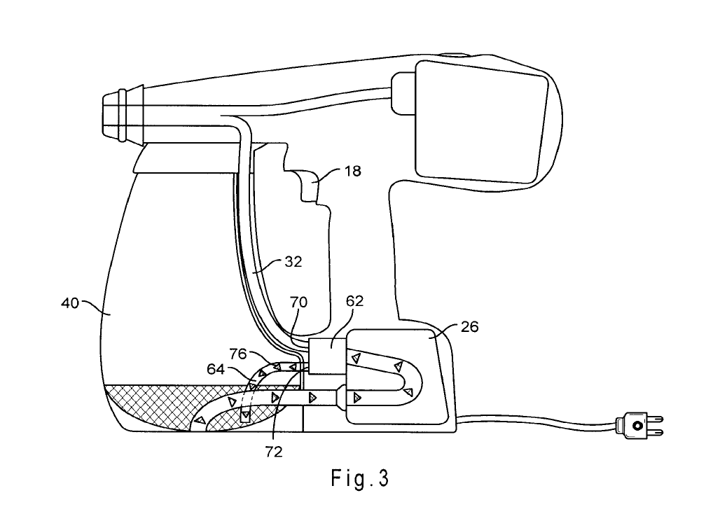

Operation of the spray mechanism with bypass valve differs from the embodiment described in FIG. 1 as follows: When the trigger 18 is actuated, the first valve opening 70 is open and the second valve opening 72 is closed. Upon entering the pump 26, the fluid will be pressurized and delivered to the bypass valve 62. While the trigger 18 is actuated, pressurized fluid will be fed through the fluid feeder line 32, indicated by arrows 74, and to the fluid injection point 36, where it will enter the air stream 60. The fluid and air stream will exit the nozzle as a spray in the manner described above. As shown in FIG. 3, once the trigger 18 is released, the first valve opening 70 closes and the second valve opening 72 opens so that any fluid being pressurized by the pump 26 does not enter the fluid feeder line 32 and instead enters the feedback hose 64, indicated by arrows 76, and is delivered back to the receptacle 40.

In addition, the bypass valve may be manually adjusted so that it enters into a bypass mode, i.e., closes the first valve opening 70 and opens the second valve opening 72, when fluid exiting the pump reaches a predetermine pressure. Such conditions may exist, for example, when fluid flow is blocked at the nozzle. Under such a condition, fluid will be “recycled” so that it passes through the feedback hose and into the receptacle.

Moreover, the bypass valve may be adjusted so that it enters into a partial bypass mode, i.e., so that only a portion of the fluid is recycled into the receptacle. Upon reaching a predetermined pressure, the bypass valve may partially close the first valve opening 70 and partially open the second valve opening 72 so that a portion of the fluid passes through the feedback hose, while the remaining fluid passes through the fluid feeder line 32. Additionally, the valve may be adjusted so that it continues to adjust the first valve opening 70 and the second valve opening 72, depending on the pressure detected in the fluid feeder line 32.

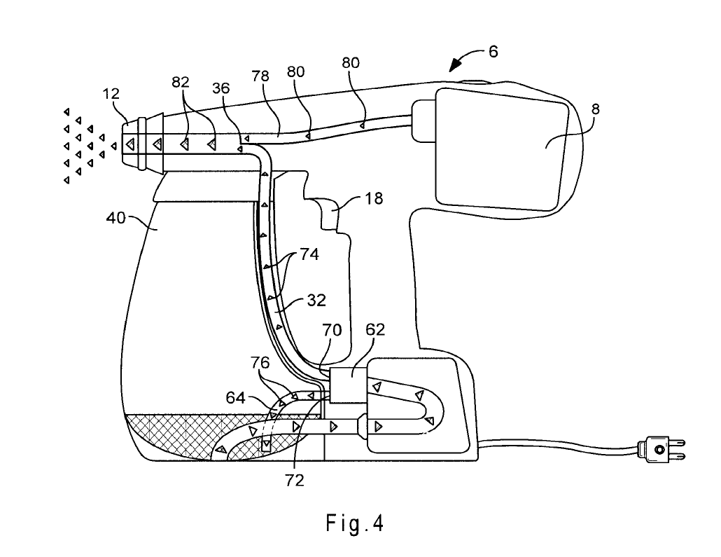

Referring to FIG. 4, the spray mechanism optionally may include a valve mechanism to control the flow of fluid. The valve mechanism is located in the nozzle and preferably is of a roller-type or needle type, although other flow control mechanisms may be used. The valve mechanism controls the bypass valve 62 so that the bypass valve openings 70, 72 may be opened/closed, or partially opened/closed, to control the amount of flow that passes through each. Fluid exiting the bypass valve 62 simultaneously is delivered to the fluid feeder line 32, indicated by arrows 74, and the feedback hose 64, indicated by arrows 76. Because fluid is diverted to both the fluid feeder line 32 and the feedback hose 64, the amount of fluid that is delivered to the fluid injection point 36 is reduced, reducing the amount of fluid that exits the nozzle 12.

Optionally, an air stream hose 78 may be fluidly connected with the blower motor 8 and the nozzle 12 for the passage of the air stream, indicated by arrows 80. In such embodiments, the fluid feeder line 32 joins with the air stream hose 78 at the fluid injection point 36. As described above, fluid from the fluid feeder line 32 is injected into the air stream, denoted as arrows 82, and exits the spray mechanism at the nozzle 12.

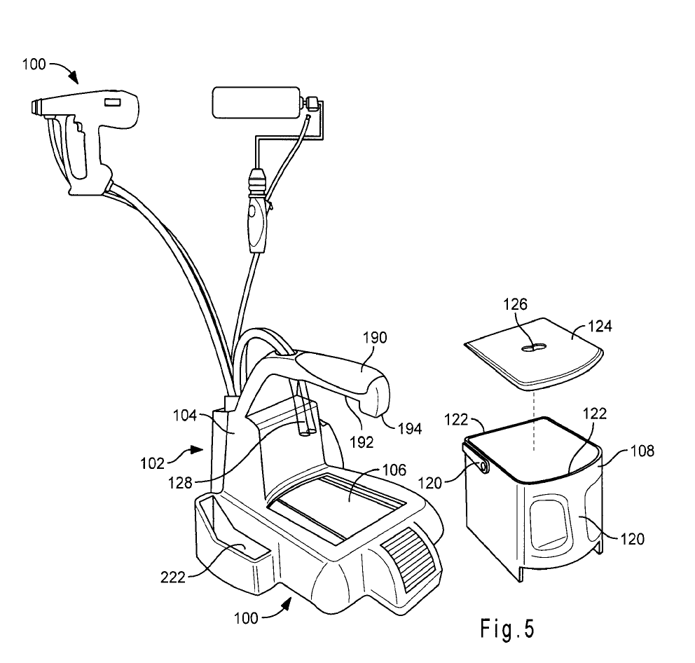

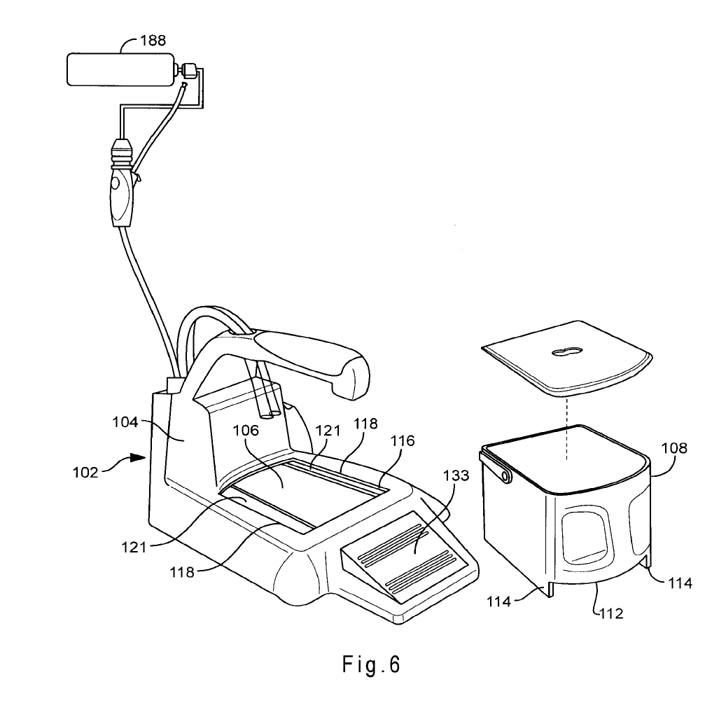

FIGS. 5 and 6 show an alternate embodiment of the sprayer system 2. The sprayer system includes a spray applicator 100 and a base station 102. The spray applicator 100 is the substantially the same as the spray applicator 6, and includes a trigger 152, a housing 156, a handle 158 and a nozzle 160. The spray applicator does not, however, include a blower motor, pump and pump motor. Instead, and as discussed below, these components are housed within the base station 102. It is contemplated, however, that the spray mechanism 6 described above with respect to FIGS. 1-4 could be used with the base station 102 described below. In this instance, each of the sprayer mechanism 6 and base station 102 would include a blower motor, pump and pump motor.

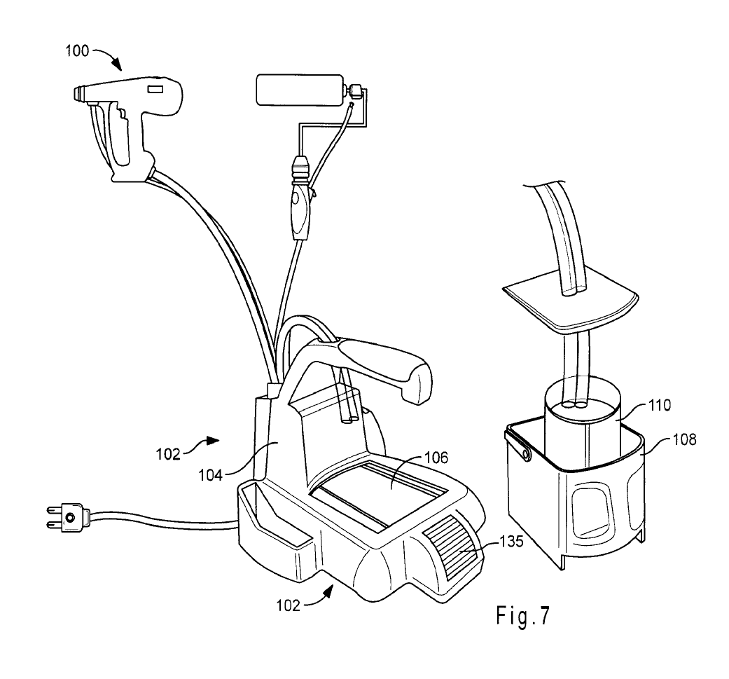

The base station includes a housing 104 and a platform 106. The platform 106 is adapted to receive a receptacle 108. The receptacle 108 may directly contain a fluid. Alternatively, the receptacle may act to hold a container 110 of fluid (FIG. 7). Preferably, the platform 106 and the receptacle 108 are adapted to enter into detachable engagement with each other. More preferably, a lower surface 112 of the receptacle may include protrusions 114 that mate with openings 120 in the platform. The receptacle may include a lip 116 around its edges 118 so that the receptacle 108 is partially recessed in the platform 106.

Advantageously, the receptacle 108 may include a handle 120 to facilitate the carrying of the receptacle and the pouring of fluid out of the receptacle. More advantageously, opposite sides 122 of the receptacle each may include a handle 120. Referring to FIG. 5, one of the handles may be foldable so that it may be moved when not in use and so as not to interfere with the base station 102. Optionally, the receptacle also may include a cover 124, such as a snap on cover, which has an opening 126 in order for hoses associated with the sprayer system.

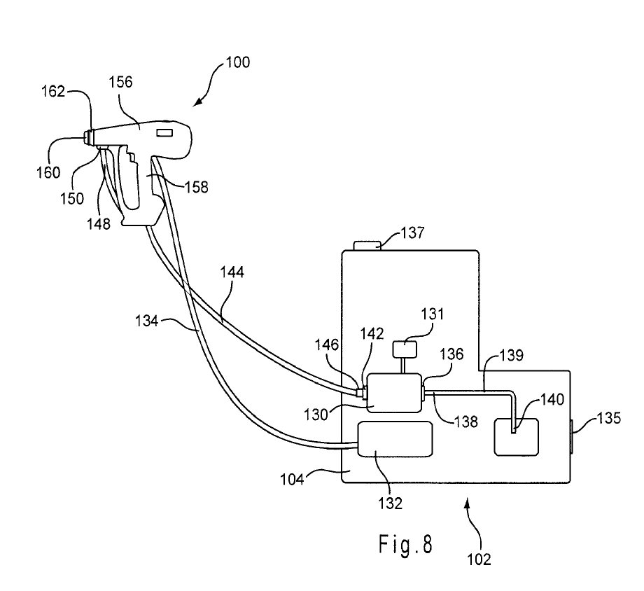

Referring to FIG. 8, the housing 104 of the base station 102 houses a pump 130, a pump motor 131 and a blower motor 132, which are similar to the pump 26, pump motor 22, and blower motor 8 described in conjunction with FIG. 1. The pump motor and blower motor may be actuated by a selector switch 133. Alternatively, the pump motor and blower motor may be actuated by a spring-loaded foot pedal 133 (FIG. 6), or may be actuated by respective switches located on the base station. A quick-connect blower hose 134 fluidly connects the blower motor 132 to the spray applicator 100 and provides a passage for a stream of air. The pump 130 includes an inlet 136 to which a fluid feed line 139 is fluidly connected at a first end 138. As described further below, a second end 140 of the fluid feed line provides for the delivery of fluid from the receptacle 108.

The pump also includes a pump outlet 142 that is fluidly attached to a first end 146 of a fluid line 144. A second end 148 of the fluid line 144 is fluidly attached to the spray applicator 100, with the area of attachment of the second end of the fluid line 144 and the spray applicator 100 forming a fluid injection point 150.

In a preferred embodiment, the base station 102 may include a handle 190 for ease of transport. Advantageously, the handle 190 may include an overhang 192 so that the receptacle 108 abuts a lower surface 194 of the handle 190 and the overhang 192. Thus, in addition to providing for transport, the handle 190 may provide another manner of securing the receptacle 108.

Operation of the base station 102 and spray applicator 100 described thus far is as follows: The receptacle 108, which contains fluid or a container having fluid, is attached to the platform 106 of the base station 102. The second end 140 of the fluid feed line 139 is inserted into the fluid. The blower motor and pump motor are actuated with the switches. The blower motor 132 blows air entering an air intake 135 through the blower hose 134. The air stream exits the blower hose 134 and passes through the handle of the spray applicator and enters the housing 156.

At the same time the air stream is being created, fluid from the receptacle 108 is drawn into the pump 130 and pressurized so that it flows through the fluid line 144 and to the fluid injection point 150. Upon reaching the fluid injection point 150, the fluid is injected into the air stream in the housing 156. The pressurized fluid combines with the air stream and exits the nozzle 160 as high-volume, low-pressure spray. As described above in conjunction with FIG. 1, an adjustment dial 162 associated with the nozzle 160 may be used to select a desired pattern.

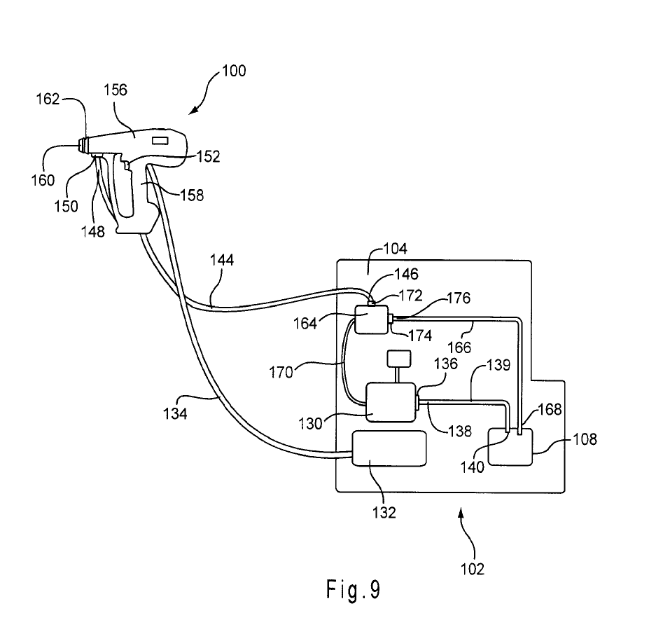

Referring to FIG. 9, an alternate embodiment of the spray applicator 100 and base station 102 of FIG. 6 is shown, with like components having like reference numerals. The base station includes a bypass valve 164 that is fluidly connected with the pump 130. The bypass valve 164 operates in a similar fashion as the bypass valve 62 described in conjunction with FIG. 2 and controls the amount of fluid delivered to the fluid injection point 150 and includes a feed back loop, or hose, 166 whose first end 168 transfers fluid to the receptacle 108. A hose 170 fluidly connects the pump 130 to the bypass valve 164. The first end 146 of the fluid line 144 is fluidly connected to a first valve opening 172 of the bypass valve 164. The feedback hose 166 is fluidly connected with a second valve opening 174 of the bypass valve at a second end 176.

Operation of the sprayer system of FIG. 9 is as follows: When the trigger 152 is actuated, the first valve opening 172 is open and the second valve opening 174 is closed. Upon entering the pump 130, the fluid will be pressurized and delivered to the bypass valve 164. While the trigger 152 is actuated, pressurized fluid will be fed through the fluid line 144 and to the fluid injection point 150, where it will be injected into the air stream inside the housing 156. The fluid and air stream will exit the nozzle as a spray in the manner described above. Once the trigger 152 is released, the first valve opening 172 closes and the second-valve opening 174 opens so that any fluid being pressurized by the pump 130 does not enter the fluid line 144 and instead enters the feedback hose 166 and is delivered back to the receptacle 108.

In additional embodiments, the bypass valve 164 may be manually adjusted or may be adjusted so that it enters into a partial bypass mode as described above in conjunction with the spray mechanism. Also like the spray mechanism described above, the nozzle of the spray applicator may include a valve mechanism in the nozzle to control the flow of fluid. In such an embodiment, the valve mechanism in the nozzle acts as the first valve opening. Thus, when the spray applicator trigger is actuated, the valve mechanism is open and the second valve opening 174 is closed to allow fluid to pass through the nozzle of the spray applicator. When the trigger 152 is released, the valve mechanism closes and the second valve opening opens so that any fluid being pressurized by the pump will not enter the fluid line. Rather, any such fluid will enter the feedback hose 166 and be delivered to the receptacle 108.

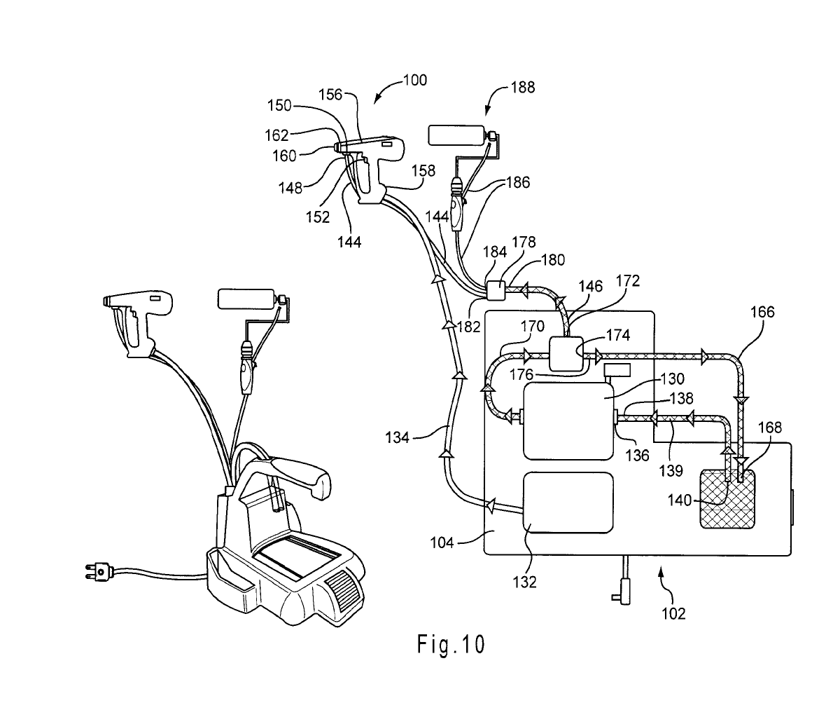

FIG. 10 shows an additional embodiment of the spray applicator and base station, with like components having like reference numerals. A quick-connect valve 178 is fluidly connected with the bypass valve at an inlet 180. The valve 178 includes two outlets, 182, 184. The fluid line 144 is connected to first outlet 182, and an implement hose 186 is connected to second outlet 184. The implement hose provides for the flow of fluid from the pump to an implement 188.

The valve 178 allows a user of the sprayer system to alternate between using the spray applicator 100 and the implement 188. Notably, and unlike the spray applicator, fluid that is transferred to the implement does not join with an air stream. In alternate embodiments, the outlets 182, 184 may simultaneously be open so that the spray applicator and implement may be used at the same time. In yet alternate embodiments, and referring to FIG. 6, the implement 188 may be used in conjunction with the base station with a spray mechanism.

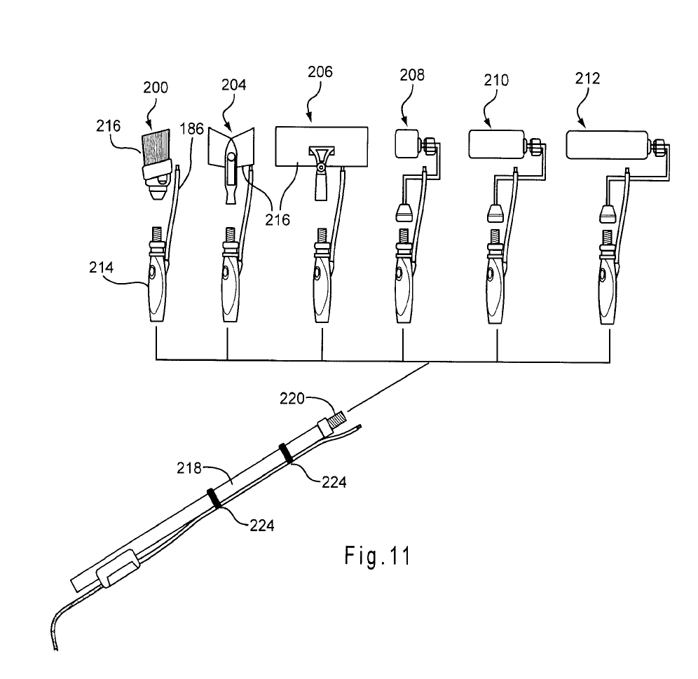

FIG. 11 provides examples of implements 188 that may be used in conjunction with the sprayer system. The implements are standard and include: a brush 200, a corner pad 204, a flat pad 206, and rollers 208, 210, and 212. In general, the implement 188 includes an accessory mount 214 and a head 216. In one embodiment, a common accessory mount may be used with a variety of detachable heads 216.

In addition, the implement may utilize an extension pole 218. The extension pole is connects to the implement 188 or accessory mount 214 via mating threads 220. The implement hose may be secured with fasteners 224 to the extension pole so as not to cause a distraction.

In embodiments that utilize a bypass valve, a valve mechanism may be located in the accessory mount of the implement. In such embodiments, the valve mechanism acts as the first valve opening. Thus, when fluid is delivered to the implement (i.e., when the sprayer system is not in the bypass mode), the valve mechanism is open and the second valve opening on the bypass valve is closed. Conversely, when the sprayer system is in a bypass mode, the valve mechanism at the accessory mount is closed and the second valve opening on the bypass valve is open so that the feedback hose may deliver fluid to the receptacle.

More detail is now provided about the actuation of the sprayer system having a base station. As noted above, the blower motor and pump motor may be actuated with a selector switch, such as a toggle switch. The selector switch allows the user to select a mode of operation, such as, for example, the use of the spray applicator, or an implement, or both. When a position for the switch is selected, a pre-determined motor combination is actuated. A valve mechanism, as described above, at each of the implement and the spray applicator permits flow to the head and the nozzle, respectively. Selections may include:

An implement application only, where the pump enters in a bypass mode as described above. A user engages the trigger at the implement to so that the valve mechanism opens and the second valve opening at the bypass valve closes to allow fluid to travel toward the implement;

A spray applicator mode, where a user engages the trigger at the spray applicator to open the valve mechanism at the nozzle and close the second valve opening at the bypass valve to allow the fluid to travel toward the spray applicator;

A “multi-fluid” application, where at least two implements are able to be operated. The pump enters into a bypass mode. Upon actuation of each implement that it is desired to use, the corresponding valve mechanism at each implement opens while the second valve opening at the bypass valve closes to allow the fluid to travel toward each implement; and

A spray applicator and implement application. The pump will initially enter into a bypass mode until the trigger for the spray applicator or implement, or both, (depending on which of the spray applicator and implement is desired), is engaged. The valve mechanism at the spray applicator and/or implement open and the second valve opening at the bypass valve closes to allow fluid flow. Of course, the selector switch may be further modified for embodiments where a bypass valve is not incorporated.

Thus, a novel sprayer system has been described herein. The advantages associated with the sprayer system are numerous. First, the sprayer system provides for the application of a fluid at a high volume and low pressure with two separate flow paths, which provides several advantages. Because the fluid is being applied at a low pressure, overspraying and splatter, which typically result under high-pressure spray applications and cause a wasting of materials, are reduced, thus conserving materials. At the same time, fluid such as paint need not be diluted because the pressure applied to the paint will be sufficient for the paint enter the fluid injection point. In prior art sprayer systems, the pressure applied to the fluid often will be too low, requiring that the fluid be diluted in order to reduce its viscosity so that it may be fed through the system. Additionally, the bypass valve provides the added advantage of providing further fluid flow control. Moreover, when the bypass valve is in a bypass, or partial bypass mode, the “recycling” of the fluid will cause the fluid in the receptacle to be agitated. Typically, during the application process, the fluid at intervals should be agitated or stirred to maintain consistency. With prior art spray systems, a user will stop the use of a spray system in order to agitate or stir the fluid.

Furthermore, because the sprayer system uses quick-connect hoses or tubes, the sprayer system may be easily adapted to utilize the bypass valve and/or the quick-connect valve. Moreover, the ease of adaptability of the sprayer system lends it to a novel method of cleaning. For the spray mechanism, water is simply flushed through the system, i.e., water is placed in the receptacle and the spray mechanism is operated. For embodiments using the base station, the ends of the fluid feeder line and feedback hose that normally are placed in the receptacle are placed in a bucket of cleaning fluid, such as soapy water. The fluid line is disconnected from the spray applicator and connected to the end of the feedback hose in the cleaning fluid, thus forming a loop. The system is then flushed with the cleaning fluid by running the pump, with the cleaning fluid being exchanged several times. The implement hose may be cleaned in a similar fashion. In addition, the spray mechanism and the base station may be provided with removable or hinged panels to allow easy access to the various components such as the valves, pump, etc. for additional cleaning or replacement. Alternately, each implement may be disconnected and the “hose-end” of each implement may be placed into a clean water bucket to allow the system to re-circulate to clean as necessary.

Unlike prior-art sprayer systems, as described above, the present invention allows the continuous operation of the sprayer system without stopping during trigger actuation. In this way, sprayer system is in a steady state condition, whether in a bypass or spray mode, and never experiences frequent start, stop cycles or high loads due to back-pressure build-up when the trigger is closed.

Additional embodiments also are possible. For example, the base station may include at least one storage compartment 222 (FIG. 5) for the storage of implements. In embodiments that include a bypass valve, the trigger may be adjusted so that the both outlets of the bypass valve are partially open, thus placing the valve in a partial bypass mode. One way of adjusting the trigger is through the inclusion of a stop that prevents the trigger from being fully engaged.

In embodiments that utilize a spray mechanism, the spray mechanism need not be used in conjunction with an attached receptacle. Instead, the ends of the pump inlet tube and the feedback hose, which may be extended in length, may be placed in a separate container of fluid, which may even include the receptacle of the base station. The spray mechanism is then operated in the fashion described above.

It is therefore intended that the foregoing detailed description be regarded as illustrative rather than limiting. For example, although in a preferred embodiment the sprayer systems use AC power, those skilled in the art will readily recognize that the sprayer system described herein could utilize a DC power source. Therefore, it is to be understood that it is the following claims, including all equivalents, that are intended to define the spirit and scope of this invention.

What is claimed is:

1. A fluid sprayer comprising:
a housing;
a motor positioned within the housing;
a pump operably coupled to the motor to draw fluid from a fluid source and pressurize the fluid; and
a blower positioned within the housing and operable to discharge an airflow into the pressurized fluid discharged by the pump.

2. The fluid sprayer of claim 1, wherein the fluid source is a receptacle removably coupled to the housing.

3. The fluid sprayer of claim 2, wherein the pump includes a pump inlet and the receptacle includes an opening in which the pump inlet is received.

4. The fluid sprayer of claim 3, further comprising a seal positioned adjacent the opening through which the pump inlet is received.

5. The fluid sprayer of claim 1, wherein the housing includes a handle and a base, and wherein at least one of the motor and the pump is positioned within the base.

6. The fluid sprayer of claim 5, wherein the motor is positioned within the handle, and wherein the pump is positioned within the base.

7. The fluid sprayer of claim 5, wherein the fluid source is a receptacle removably coupled to the housing, wherein the receptacle and the base each include a lower surface, and wherein the respective lower surfaces of the receptacle and the base are substantially co-planar.

8. The fluid sprayer of claim 1, wherein the housing includes an outlet end through which a mixture of the pressurized fluid and the airflow is discharged.

9. The fluid sprayer of claim 8, wherein the housing includes an opening located between the outlet end and the blower, and wherein the fluid sprayer further includes a hose having a first end in fluid communication with the opening to define an injection point and a second end in fluid communication with the pump to receive pressurized fluid from the pump.

10. The fluid sprayer of claim 9, wherein the first end of the hose is received within the opening.

11. The fluid sprayer of claim 9, wherein the hose is a first hose, and wherein the fluid sprayer further includes a second hose having a first end in fluid communication with the first end of the first hose, and a second end in fluid communication with the blower to receive the airflow from the blower.

12. The fluid sprayer of claim 11, wherein the respective first ends of the first hose and the second hose merge to define an injection point.

13. The fluid sprayer of claim 9, further comprising a bypass valve positioned between the second end of the hose and the pump.

14. The fluid sprayer of claim 13, wherein the bypass valve includes a first valve opening in fluid communication with the second end of the hose, and a second valve opening in fluid communication with the fluid source to return fluid diverted from the first hose to the fluid source.

15. The fluid sprayer of claim 14, further comprising a return line fluidly communicating the second valve opening and the fluid source to return fluid diverted from the first hose to the fluid source.

16. The fluid sprayer of claim 14, further comprising a valve mechanism operable to control the flow rate of fluid returned to the fluid source.

17. The fluid sprayer of claim 8, further comprising a nozzle coupled to the outlet end of the housing through which the mixture of pressurized fluid and airflow is discharged.

18. The fluid sprayer of claim 17, wherein the nozzle includes an adjustable dial configured to shape the discharged mixture of pressurized fluid and airflow into a plurality of different patterns.

19. The fluid sprayer of claim 1, further comprising an electrical cord for connecting the motor and the blower to an AC power source.

20. The fluid sprayer of claim 1, wherein the blower is configured to supply a high-volume, low-pressure airflow to the pressurized fluid discharged by the pump.
